(19) United States
(12) Patent Application Publication
(10) Pub. No.: US 2026/0299786 A1
(43) Pub. Date: Oct. 1, 2026

(54) HOST WORKLOAD BASED ADDRESS TABLE UPDATE MANAGEMENT IN DATA STORAGE DEVICES

(71) Applicant: Sandisk Technologies, Inc., Milpitas, CA (US)

(72) Inventors: ABHINANDAN VENUGOPAL, BENGALURU (IN); AMIT SHARMA, BENGALURU (IN); ARUN KANNAN, BENGALURU (IN)

(73) Assignee: Sandisk Technologies, Inc., Milpitas, CA (US)

(21) Appl. No.: 19/089,263

(22) Filed: Mar. 25, 2025

(51) Int. Cl. G06F 3/06; G06F 12/1009

(52) U.S. Cl. CPC G06F 3/0613; G06F 3/0659; G06F 3/0679; G06F 12/1009

(57) ABSTRACT

A storage device may improve random write processing and performance. The storage device includes a persistent memory to store a logical-to-physical (L2P) table that includes a mapping of logical block addresses in a host command to physical addresses on the memory device. The storage device also includes a volatile memory including a cache address table to store msets in the L2P table and a ulayer to store updates to msets in the L2P table. A controller on the storage device may receive host commands and track a set of incoming host commands to determine a host workload. The controller may trigger a first state on the storage device based on a first host workload, disable interaction with the cache address table, and update the ulayer with mapping information in the host command while the storage device is in the first state.

### BACKGROUND OF THE INVENTION

A storage device may be communicatively coupled to a host and to non-volatile memory including, for example, a NAND flash memory device on which the storage device may store data received from the host. The memory device may include multiple dies which may be divided into physical blocks and the storage device may store data in blocks on the memory device. The host may assign a logical block address (LBA) to a unit of data stored in the blocks on the memory device. The LBAs may be mapped one-to-one to physical addresses on the memory device and the mappings may be stored in a logical-to-physical (L2P) table. A controller on the storage device may manage the mappings in the L2P table so that when the host issues a command to access a unit of data, the controller may retrieve the data based on the mappings in the L2P table.

A range of LBAs may be stored as an mset. The controller may cache a limited set of msets in a cache address table (CAT) in a volatile memory (for example, a random-access memory (RAM)) on the storage device to quickly access the msets cached in the CAT. The CAT may be indexed linearly to quickly update the L2P table, resulting in lower processing overheard.

Random read/write benchmarks may be critical to the performance of the storage device. Storage devices may support different range requirements (for example, one gigabyte (GB), 32GB or 64GB random read/write benchmarks) and may have different CAT budgets. The RAM space may be limited and as such the size of the CAT may be restricted, particularly in storage devices that do not include large volatile memory. As the capacity of the storage device increases, the range of LBAs in the storage device may also increase, even as the CAT size may remain the same. For a long-range random write workload, the range of LBAs covered in the CAT may be low. For example, for a 32GB workload, the CAT may store less than three percent of the msets at a time and for a 64GB workload, the CAT may store less than one percent of the msets at a time. For a long-range random write workload where a CAT update may occur for approximately one-two percent of the host commands, interfacing with the CAT for every long-range random write command to determine if the LBA in the command is in the CAT may incur overhead which may impact the storage device performance.

When the storage device is processing a host write command, if an mset including the LBA in the write command is stored in the CAT, the mset may be updated, and if the mset is stored in the memory device, the controller may store the mset update in a temporary location (i.e., an update layer (layer)) that is not linearly indexed. For a long-range random-write workload most of the updates may be performed on ulayer. The controller may accumulate updates in the ulayer and when the accumulated updates reach a threshold, the controller may trigger consolidation to synchronize updated msets in the ulayer with data in the CAT or the memory device and free space in the ulayer.

With a long-range workload, the ulayer threshold may be reached quickly, increasing the consolation frequency. Frequent consolidations may contribute to a drop in the long-range random-write performance as consolidation is a processing intensive operation Consider an example where the ulayer supports approximately 24000 entries and approximately twenty-four updates per mset may occur when consolidation is triggered during a 32GB long-range workload. When eight msets are selected during a consolidation, only about 200 entries would be freed up after the consolidation and these entries may quickly be used for new host commands, leading to back-to-back consolidations.

Consolidation efficiency may be lowered as the random-write workload ranges increase. On, for example, a 64GB workload range, the ulayer entries that are cleaned up per consolidation, may be lower than incoming entries into the ulayer.

This may result in the storage device entering a low resource mode wherein host commands may be blocked. To unblock the host commands, more consolidations may be triggered which may increase deterministic consolidation overheads and further impact the performance on the storage device. To improve the random performance of a storage device, a conventional approach has been to linearly increase the processing power and/or add more RAM on the storage device. This approach is costly and may not be feasible on a low-cost storage device.

### SUMMARY OF THE INVENTION

In some implementations, a storage device may improve random write processing and performance on the storage device. The storage device includes a persistent memory to store a logical-to-physical (L2P) table that includes a mapping of logical block addresses in a host command to physical addresses on the memory device. The storage device also includes a volatile memory including a cache address table to store msets in the L2P table and a ulayer to store updates to msets in the L2P table. A controller on the storage device may receive host commands and track a set of incoming host commands to determine a host workload. The controller may trigger a first state on the storage device based on a first host workload, disable interaction with the cache address table, and update the ulayer with mapping information in the host command while the storage device is in the first state.

In some implementations, a storage device may improve random write processing and performance on the storage device. The storage device includes a persistent memory to store a L2P table that includes a mapping of logical block addresses in a host command to physical addresses on the memory device. The storage device also includes a volatile memory including a cache address table to store msets in the L2P table and a ulayer to store updates to msets in the L2P table. A controller on the storage device may receive a host write command and track a set of incoming host commands to determine a host workload. The controller may trigger a first state on the storage device based on a first host workload, disable interaction with the cache address table, and update the ulayer with mapping information in the host write command while the storage device is in the first state. The controller may trigger a second state on the storage device based on a second host workload and enable interaction with the cache address table while the storage device is in the second state.

In some implementations, a method is provided on the storage device for. improving random write processing and performance on a storage device. The method includes receiving host commands and tracking a set of incoming host commands to determine a host workload. The method also includes triggering a first state on the storage device based on a first host workload. The method further includes disabling interaction with a cache address table and updating a ulayer with mapping information in the host command while the storage device is in the first state.

### BRIEF DESCRIPTION OF THE DRAWINGS

FIG. 1 is a schematic block diagram of an example system in accordance with some implementations.

FIG. 2 is an example block diagram of a cache address table (CAT) in accordance with some implementations.

FIG. 3 is an example flow diagram for processing a long-range random write workload in accordance with some embodiments.

FIG. 4 is an example flow diagram for performing ulayer consolidation when in CAT-skip state in accordance with some embodiments.

FIG. 5 is an example flow diagram for processing a non-long-range random write workload in accordance with some embodiments

FIG. 6 is a diagram of an example environment in which systems and/or methods described herein are implemented.

FIG. 7 is a diagram of example components of one or more devices of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of implementations of the present disclosure.

The apparatus and method components have been represented where appropriate by conventional symbols in the drawings, showing those specific details that are pertinent to understanding the implementations of the present disclosure so as not to obscure the disclosure with details that will be readily apparent to those of ordinary skill in the art.

### DETAILED DESCRIPTION OF THE INVENTION

The following detailed description of example implementations refers to the accompanying drawings. The same reference numbers in different drawings may identify the same or similar elements.

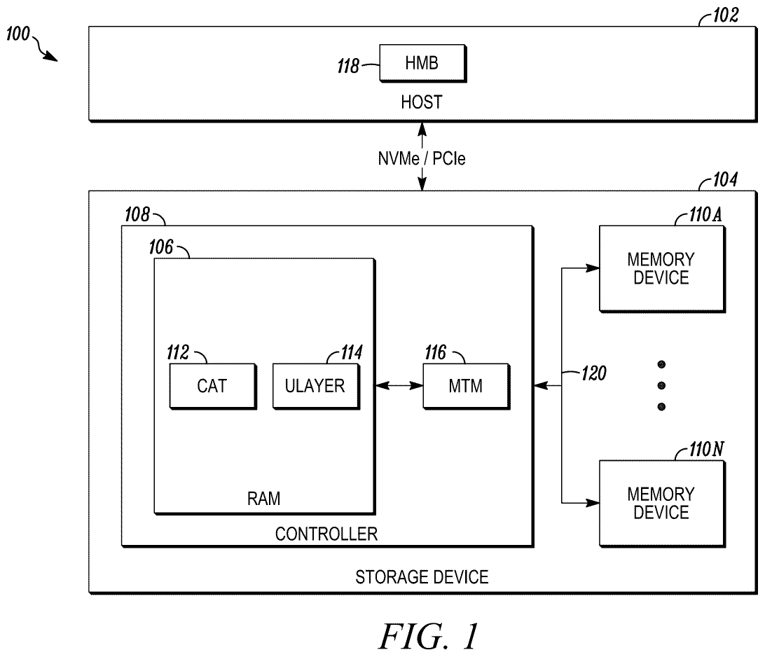

FIG. 1 is a schematic block diagram of an example system in accordance with some implementations. System 100 may include a host 102 and a storage device 104 that may be in the same physical location as components on a single computing device or on different computing devices that are communicatively coupled. Storage device 104 may communicate with host 102 via a Non-Volatile Memory Express (NVMe) protocol over a peripheral component interconnect express (PCIe) bus, and the like. Host 102 may include additional components (not shown in this figure for the sake of simplicity).

Storage device 104 may be, for example, a solid-state drive (SSD) that may include a random-access memory (RAM) 106, a controller 108, and one or more storage components such as non-volatile memory devices 110a-110n (referred to herein as the memory device(s) 110). RAM 106 may be, for example, static RAM (SRAM) or dynamic RAM (DRAM) that be used to temporarily store data on storage device 104. For example, RAM 106 may store portions of a logical-to-physical (L2P) table that may be used to map a logical block address (LBA) in a host command to a physical address on memory device 110.

Controller 108 may interface with host 102 and process foreground operations including instructions transmitted from host 102. For example, controller 108 may read data from and/or write to memory device 110 based on instructions received from host 102. Controller 108 may also execute background operations to manage resources on memory device 110. For example, controller 108 may monitor memory device 110 and may execute garbage collection and other relocation functions per internal relocation algorithms to refresh, recycle, and/or relocate the data on memory device 110.

Memory device 110 may be flash based. For example, memory device 110 may be a NAND or NOR flash memory that may be used for storing host and control data over the operational life of memory device 110. Memory device 110 may include one or more dies connected to a memory bus 120 including data lines and chip enable lines. The dies may be divided into blocks and data may be stored in the blocks in various formats, with the formats being defined by the number of bits that may be stored per memory cell. Memory device 110 may be included in storage device 104 or may be otherwise communicatively coupled to storage device 104.

Storage device 104 may be expected to meet predefined random workload benchmarks. For example, storage device 104 may be designed to meet a standard 1 GB random read/write performance benchmark and may include a 1 mega-byte (MB) cache address table (CAT) 112. CAT 112 may include a limited number, for example, thirty-two, of slots, that may support the 1GB workload range. Storage device 104 may also be designed to meet long-range random workloads including, for example, 32 GB or 64 GB random workloads. In an example where storage device 104 supports a 32 GB random workload and includes a 1 MB CAT 112, only 1/32 GB msets may be cached in CAT 112 at a time (i.e., because a 1 MB CAT 112 may support a 1 GB range). Similarly, in an example where storage device 104 supports a 64 GB random-read workload and includes a 1 MB CAT 112, only 1/64 GB msets may be cached in CAT 112 at a time.

In a conventional approach, when performing an L2P translation for a host random-read request, controller 108 may first refer to CAT 112. As part of the L2P translation, controller 108 may check a CAT header for an mset identifier to determine if a slot in CAT 112 includes the mset that has the LBA in the random-read request. If the mset is in CAT 112, controller 108 may check an erase bitmap to determine if the mset is erased, lock the slot in CAT 112 before performing the L2P translation to prevent another command from evicting the data in the slot, and check the slot for an invalid Uncorrectable Error Correction Code (UECC). Controller 108 may thereafter translate the LBA to a physical address based on the information obtained from CAT 112. If the mset including the LBA in the random-read request is not in CAT 112, controller 108 may check an update layer (ulayer 114) that may include unlinked L2P updates.

If the associated mset is not in CAT 112 or ulayer 114, controller 108 may determine if the mset is stored in a host memory buffer (HMB) 118. HMB 118 may be a buffer on host 102 that may be used by storage device 104, wherein storage device may cache portions of the L2P table in HMB 118. Accessing the L2P information from HMB 118 may incur host protocol latencies. As a last resort, if the mset including the LBA in the random-read request is not in CAT 112, ulayer 114, or HMB 118, controller 108 may have the mset loaded from memory device 110 to CAT 112 to perform the L2P translation. Using this conventional approach, about thirty-five percent of the processing time for a random-read command may be used for L2P translation, which may be a bottleneck for random-read performance.

Msets in CAT 112 may be evicted/copied/flushed to HMB 118 and/or memory device 110. After the mset is evicted from CAT 112, the mset may remain in CAT 112 and may continue to be accessed in CAT 112 unless the entry in CAT 112 storing the mset is needed for a different purpose. At which point, the mset may no longer be stored in CAT 112.

In a conventional approach, when controller 108 receives a random workload or a sequential workload including host write requests, controller 108 may interact with CAT 112 to determine if an mset including the LBA in a host write request is stored in CAT 112. If the mset including the LBA in the host write request is stored in CAT 112, controller 108 may update the mset in CAT 112. If the mset including the LBA in the host write request is not stored in CAT 112, controller 108 may add the L2P update for each host write command to a delta list in ulayer 114. Controller 108 may perform compaction of the deltas (i.e., consolidation of ulayer 114) once a threshold is reached. The delta heap and L2P cache may require a large RAM 106, which may not be feasible with a lower cost storage device 104 with comparatively lower performance requirements. In addition, performing L2P updates may be processing intensive and the time used for each L2P update may be approximately 400 nanoseconds (ns).

When storage device 104 is processing a long-range random write workload, the CAT hit percentage may be low. For example, when storage device 104 is processing a long-range random write workload, the chance that the mset including the LBA in the host write is stored in CAT 112 may be less than two percent. In an implementation, controller 108 may track a predefined set of incoming host commands to determine a host working range and the host workload. The host working range could be, for example, 1 GB, 16 GB, 32 GB, or 64 GB, wherein 16 GB, 32 GB, or 64 GB may be identified as long-range. The host workload may be, for example, a sequential workload (i.e., sequential host read/writes) or a random workload (i.e., random host read/writes).

When controller 108 identifies a long-range random write workload (referred to herein as a first host workload), controller 108 may trigger a CAT-skip state (referred to herein as a first state). In the CAT-skip/first state, controller may flush the msets in CAT 112 to a management table module (MTM) 116 which may manage the loading of msets to and from memory device 110 and CAT 112. MTM 116 may load the msets sent from CAT 112 into management table blocks in memory device 110 which may store the L2P mappings persistently. Controller 108 may invalidate the mset mappings in CAT 116 to ensure that the msets in CAT 112 are inaccessible while storage device 104 is in the CAT-skip state. For example, controller 108 may unmap the mset indexes in CAT 112 to ensure that the msets in CAT 112 are inaccessible while storage device 104 is in the CAT-skip state.

In the CAT-skip state, controller 108 108 may disable interaction with CAT 112 and may bypass updating the msets in CAT 112 with the LBA in the host write command. Instead, controller 108 may directly update ulayer 114 even if a corresponding mset including the LBA in the long-range random write command is stored in CAT 112. As such, in the CAT-skip state, controller 108 may disable interactions with CAT 112 when processing the first host workload (i.e. long-range random write commands).

When storage device is in the CAT-skip state, controller 108 may use some of the slots in CAT 112 for L2P compaction of deltas in ulayer 114. After a consolidation of ulayer 114 is complete, controller 108 may flush the msets from the consolidation that are stored in CAT 112 to MTM 116 and invalidate the mset mappings in CAT 112. When controller 108 is in the CAT-skip state, controller 108 may avoid the processing overhead associated with interacting with CAT 112. The avoided interactions with CAT 112 may reduce the approximately 400 ns associated with L2P updates by approximately 20 ns for each long-range random write command processed by storage device 104, thus improving the performance of storage device 104.

Controller 108 may track the predefined set of incoming host commands on a continuous or periodic basis. When controller 108 identifies a second host workload that is not a long-range random write workload, controller 108 may trigger a non-CAT-skip state (referred to herein as a second state). Controller 108 may also trigger the non-CAT-skip state when storage device 104 enters an idle state or a low power mode. In the non-CAT-skip state, controller 108 may enter a L2P management mode wherein updates to CAT 112 may be enabled. For example, in the non-CAT-skip state, MTM 116 may load msets in CAT 112 and upon receipt of a host command, controller 108 may determine if the mset including the LBA in the host request is stored in CAT 112. If the mset including the LBA in the host request is stored in CAT 112, controller 108 may update the mset in CAT 112. If the mset including the LBA in the host request is not stored in CAT 112, controller 108 may add the L2P update to a delta list in ulayer 114 and perform compaction of the deltas (i.e., consolidation of ulayer 114) once a threshold is reached.

Controller 108 may enter or remain in the non-CAT-skip state when controller 108 identifies the second host workload as a long-range random read workload. When controller 108 receives a long-range random read workload from host 102, controller 108 may determine if the mset including the LBA in the host read request is stored in CAT 112. If the mset including the LBA in the host read request is stored in CAT 112, controller 108 may perform the L2P translation using the mset in CAT 112. If the mset including the LBA in the host read request is not stored in CAT 112, controller 108 may determine if the mset including the LBA in the host read request is in ulayer 114. If the mset including the LBA in the host read request is in ulayer 114, controller 108 may perform the L2P translation using the mset in ulayer 114. Controller 108 may facilitate maintaining a chronology of L2P updates by flushing the entire contents of CAT 112 to MTM 116 when storage device 104 enters the CAT-skip state and invalidating the msets mappings in CAT 112 to ensure that the msets in CAT 112 are inaccessible.

Storage device 104 may perform these processes based on one or more processors, for example, controller 108 (and/or one or more of the component of controller 108) executing software instructions stored by a non-transitory computer-readable medium, such as storage component that is, for example, memory device 110. As used herein, the term “computer-readable medium” refers to a non-transitory memory device. Software instructions may be read into storage component from another computer-readable medium or from another device. When executed, software instructions stored in storage component may cause controller 108 (and/or one or more of the component of controller 108) to perform one or more processes described herein. Additionally, or alternatively, hardware circuitry may be used in place of or in combination with software instructions to perform one or more processes described herein. Thus, implementations described herein are not limited to any specific combination of hardware circuitry and software. System 100 may include additional components (not shown in this figure for the sake of simplicity). FIG. 1 is provided as an example. Other examples may differ from what is described in FIG. 1.

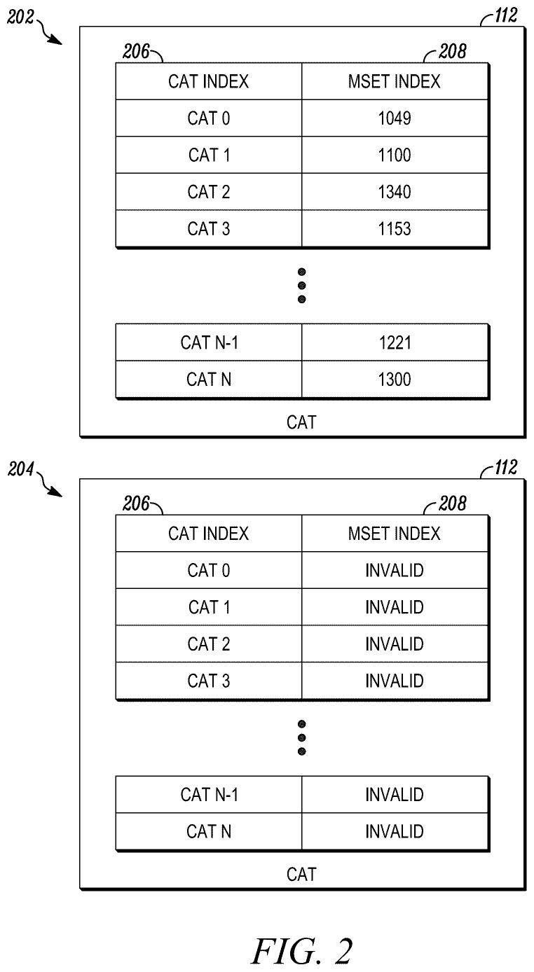

FIG. 2 is an example block diagram of a cache address table (CAT) in accordance with some implementations. 202 shows CAT 112 when storage device 104 is in a second/non-CAT-skip state. CAT 112 includes a CAT index field 206 and a mset index field 208. CAT index field 206 may include entries for identifying a CAT slot (for example CAT 0-CAT N). Mset index field 208 may include entries that are associated with CAT index field 206, where each entry in mset index field 208 may identify an index for a mset cached in CAT 112.

204 shows CAT 112 when storage device 104 is in a first/CAT-skip state. The CAT index field 206 shown in 204 may include entries for identifying a CAT slot (for example CAT 0-CAT N). Mset index field 208 shown in 204 may include entries that are associated with CAT index field 206, where each entry in mset index field 208 that may be invalidated. As indicated above FIG. 2 is provided as an example. Other examples may differ from what is described in FIG. 2.

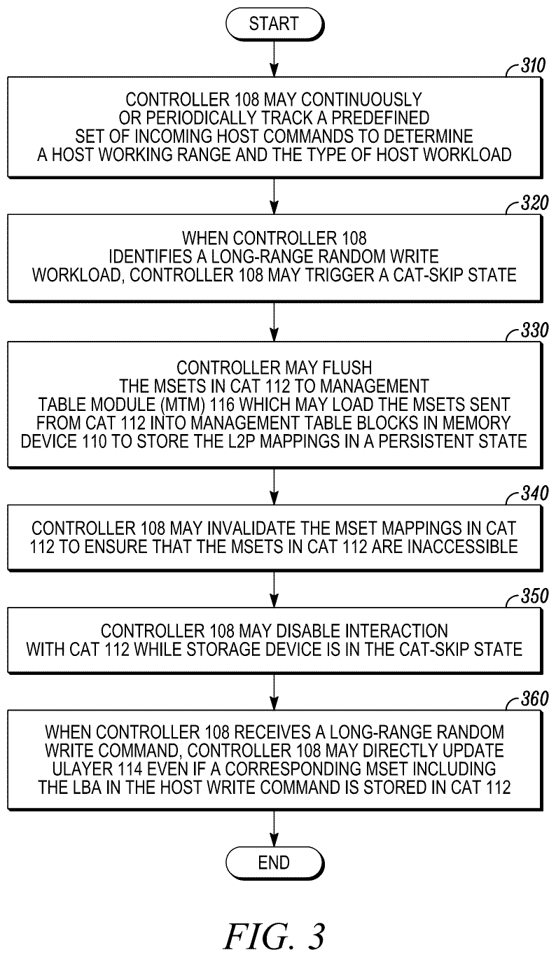

FIG. 3 is an example flow diagram for processing a long-range random write workload in accordance with some embodiments. At 310, controller 108 may continuously or periodically track a predefined set of incoming host commands to determine a host working range and the type of host workload. At 320, when controller 108 identifies a long-range random write workload, controller 108 may trigger a CAT-skip state. At 330, controller may flush the msets in CAT 112 to management table module (MTM) 116 which may load the msets sent from CAT 112 into management table blocks in memory device 110 to store the L2P mappings in a persistent state. At 340, controller 108 may invalidate the mset mappings in CAT 112 to ensure that the msets in CAT 112 are inaccessible. At 350, controller 108 may disable interaction with CAT 112 while storage device is in the CAT-skip state. At 360, when controller 108 receives a long-range random write command, controller 108 may directly update ulayer 114 even if a corresponding mset including the LBA in the host write command is stored in CAT 112. As indicated above FIG. 3 is provided as an example. Other examples may differ from what is described in FIG. 3.

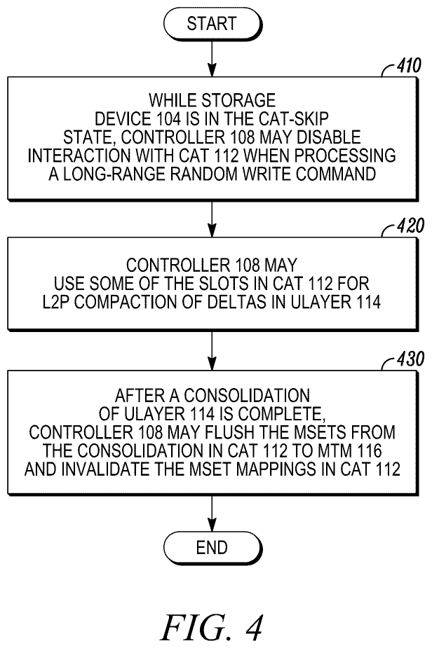

FIG. 4 is an example flow diagram for performing ulayer consolidation when in CAT-skip state in accordance with some embodiments. At 410, while storage device 104 is in the CAT-skip state, controller 108 may disable interaction with CAT 112 when processing a long-range random write command. At 420 controller 108 may use some of the slots in CAT 112 for L2P compaction of deltas in ulayer 114. At 430, after a consolidation of ulayer 114 is complete, controller 108 may flush the msets from the consolidation in CAT 112 to MTM 116 and invalidate the mset mappings in CAT 112. As indicated above FIG. 4 is provided as an example. Other examples may differ from what is described in FIG. 4.

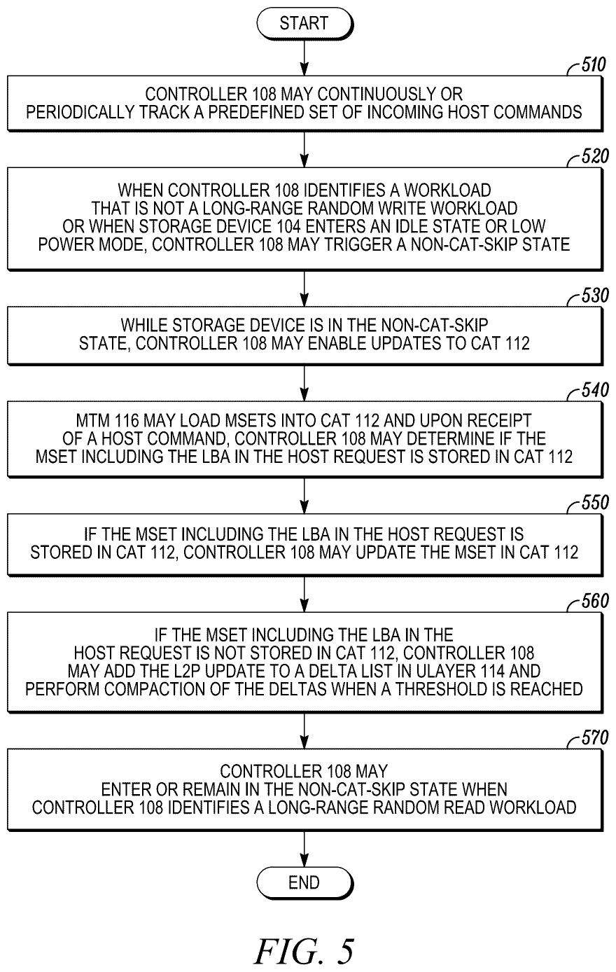

FIG. 5 is an example flow diagram for processing a non-long-range random write workload in accordance with some embodiments. At 510, controller 108 may continuously or periodically track a predefined set of incoming host commands. At 520, when controller 108 identifies a workload that is not a long-range random write workload or when storage device 104 enters an idle state or low power mode, controller 108 may trigger a non-CAT-skip state. At 530, while storage device is in the non-CAT-skip state, controller 108 may enable updates to CAT 112. At 540, MTM 116 may load msets into CAT 112 and upon receipt of a host command, controller 108 may determine if the mset including the LBA in the host request is stored in CAT 112. At 550. if the mset including the LBA in the host request is stored in CAT 112, controller 108 may update the mset in CAT 112. At 560, if the mset including the LBA in the host request is not stored in CAT 112, controller 108 may add the L2P update to a delta list in ulayer 114 and perform compaction of the deltas when a threshold is reached. At 570, controller 108 may enter or remain in the non-CAT-skip state when controller 108 identifies a long-range random read workload. As indicated above FIG. 5 is provided as an example. Other examples may differ from what is described in FIG. 5.

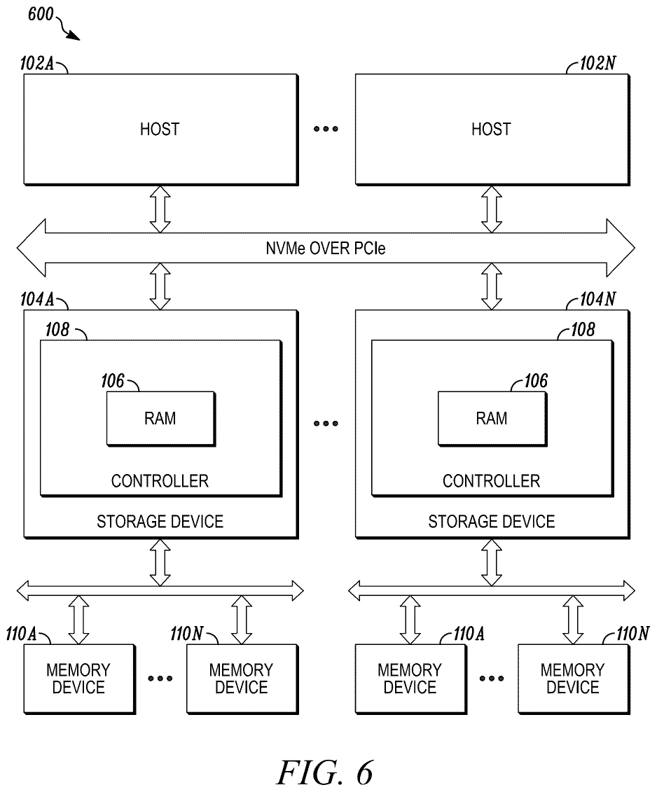

FIG. 6 is a diagram of an example environment in which systems and/or methods described herein are implemented. As shown in FIG. 6, Environment 600 may include hosts 102-102n (referred to herein as host(s) 102), and one or more storage devices 104a-104n (referred to herein as storage device(s) 104). Controller 108 may translate a logical block address to a physical address on a memory device using a swift access table. Hosts 102 and storage devices 104 may communicate via Non-Volatile Memory Express (NVMe) over peripheral component interconnect express (PCI Express or PCIe), SD, or the like.

Devices of Environment 600 may interconnect via wired connections, wireless connections, or a combination of wired and wireless connections. For example, the network in FIG. 6 may include NVMe over Fabric(NVMe-oF) Internet Small Computer Systems Interface (iSCSI), Fibre Channel (FC), Fibre Channel Over Ethernet (FCOE) connectivity and any another type of next-generation network and storage protocols, a local area network (LAN), a wide area network (WAN), a metropolitan area network (MAN), a private network, an ad hoc network, an intranet, the Internet, a fiber optic-based network, a cloud computing network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices.

Additionally, or alternatively, a set of devices (e.g., one or more devices) of Environment 600 may perform one or more functions described as being performed by another set of devices of Environment 600.

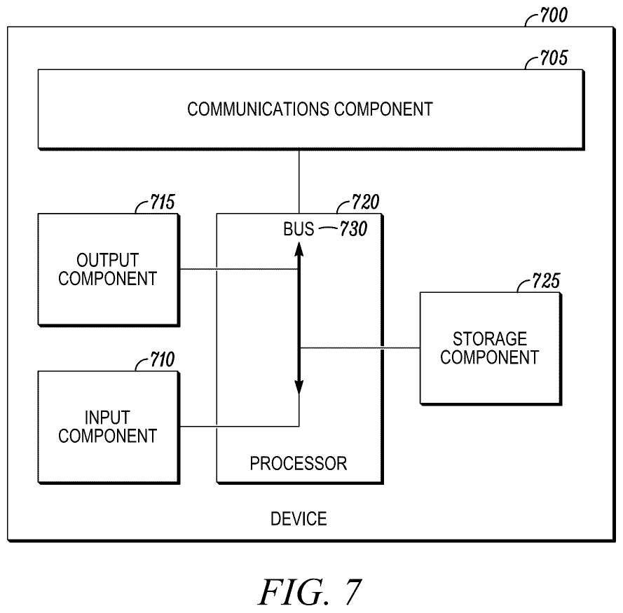

FIG. 7 is a diagram of example components of one or more devices of FIG. 1. In some implementations, host 102 may include one or more devices 700 and/or one or more components of device 700. Device 700 may include, for example, a communications component 705, an input component 710, an output component 715, a processor 720, a storage component 725, and a bus 730. Bus 730 may include components that enable communication among multiple components of device 700, wherein components of device 700 may be coupled to be in communication with other components of device 700 via bus 730.

Input component 710 may include components that permit device 700 to receive information via user input (e.g., keypad, a keyboard, a mouse, a pointing device, and a network/data connection port, or the like), and/or components that permit device 700 to determine the location or other sensor information (e.g., an accelerometer, a gyroscope, an actuator, another type of positional or environmental sensor). Output component 715 may include components that provide output information from device 700 (e.g., a speaker, display screen, and network/data connection port, or the like). Input component 710 and output component 715 may also be coupled to be in communication with processor 720.

Processor 720 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 720 may include one or more processors capable of being programmed to perform a function. Processor 720 may be implemented in hardware, firmware, and/or a combination of hardware and software.

Storage component 725 may include one or more memory devices, such as random-access memory (RAM 106), read-only memory (ROM), and/or another type of dynamic or static storage device (e.g., a flash memory, a magnetic memory, and/or optical memory) that stores information and/or instructions for use by processor 720. A memory device may include memory space within a single physical storage device or memory space spread across multiple physical storage devices. Storage component 725 may also store information and/or software related to the operation and use of device 700. For example, storage component 725 may include a hard disk (e.g., a magnetic disk, an optical disk, and/or a magneto-optic disk), a solid-state drive (SSD), a compact disc (CD), a digital versatile disc (DVD), a floppy disk, a cartridge, a magnetic tape, CXL device and/or another type of non-transitory computer-readable medium, along with a corresponding drive.

Communications component 705 may include a transceiver-like component that enables device 700 to communicate with other devices, such as via a wired connection, a wireless connection, or a combination of wired and wireless connections. The communications component 705 may permit device 700 to receive information from another device and/or provide information to another device. For example, communications component 705 may include an Ethernet interface, an optical interface, a coaxial interface, an infrared interface, a radio frequency (RF) interface, a universal serial bus (USB) interface, a Wi-Fi interface, and/or a cellular network interface that may be configurable to communicate with network components, and other user equipment within its communication range.

Communications component 705 may also include one or more broadband and/or narrowband transceivers and/or other similar types of wireless transceiver configurable to communicate via a wireless network for infrastructure communications. Communications component 705 may also include one or more local area network or personal area network transceivers, such as a Wi-Fi transceiver or a Bluetooth transceiver.

Device 700 may perform one or more processes described herein. For example, device 700 may perform these processes based on processor 720 executing software instructions stored by a non-transitory computer-readable medium, such as storage component 725. As used herein, the term “computer-readable medium” refers to a non-transitory memory device. Software instructions may be read into storage component 725 from another computer-readable medium or from another device via communications component 705. When executed, software instructions stored in storage component 725 may cause processor 720 to perform one or more processes described herein. Additionally, or alternatively, hardware circuitry may be used in place of or in combination with software instructions to perform one or more processes described herein. Thus, implementations described herein are not limited to any specific combination of hardware circuitry and software.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

The foregoing disclosure provides illustrative and descriptive implementations but is not intended to be exhaustive or to limit the implementations to the precise form disclosed herein. One of ordinary skill in the art will appreciate that various modifications and changes can be made without departing from the scope of the present disclosure as set forth in the claims below. Accordingly, the specification and figures are to be regarded in an illustrative rather than a restrictive sense, and all such modifications are intended to be included within the scope of present teachings.

As used herein, the term “component” is intended to be broadly construed as hardware, firmware, and/or a combination of hardware and software. It will be apparent that systems and/or methods described herein may be implemented in different forms of hardware, firmware, and/or a combination of hardware and software,

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related items, unrelated items, and/or the like), and may be used interchangeably with “one or more.” The term “only one” or similar language is used where only one item is intended. Further, the phrase “based on” is intended to mean “based, at least in part, on” unless explicitly stated otherwise.

Moreover, in this document, relational terms such as first and second, top and bottom, and the like, may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, or “contains . . . a” does not, without more constraints, preclude the existence of additional identical elements in the process, method, article, or apparatus that comprises, has, includes, contains the element. The terms “substantially”, “essentially”, “approximately”, “about” or any other version thereof, are defined as being close to as understood by one of ordinary skill in the art, and in one non-limiting implementation, the term is defined to be within 10%, in another implementation within 5%, in another implementation within 1% and in another implementation within 0.5%. The term “coupled” as used herein is defined as connected, although not necessarily directly and not necessarily mechanically. A device or structure that is “configured” in a certain way is configured in at least that way but may also be configured in ways that are not listed.

1. A storage device to improve random write processing and performance on the storage device, the storage device comprises:
a persistent memory to store a logical-to-physical (L2P) table that includes a mapping of logical block addresses in a host command to physical addresses on the persistent memory;
a volatile memory including a cache address table to store msets in the L2P table and a ulayer to store updates to msets in the L2P table; and
a controller to receive a command, track a set of incoming host commands to determine a host workload, trigger a first state on the storage device based on a first host workload, and disable interaction with the cache address table and update the ulayer with mapping information in the host command while the storage device is in the first state.

2. The storage device of claim 1, wherein the host workload is a long-range random write workload.

3. The storage device of claim 1, wherein the controller flushes msets in the cache address table to the persistent memory and invalidates mset mappings in the cache address table when the storage device enters the first state.

4. The storage device of claim 1, wherein the controller uses slots in the cache address table for consolidation of the ulayer while the storage device is in the first state.

5. The storage device of claim 4, wherein the controller flushes msets in the cache address table to the persistent memory and invalidates mset mappings in the cache address table while the storage device is in the first state.

6. The storage device of claim 1, wherein the controller tracks the set of incoming host commands on one of a continuous basis and a periodic basis.

7. The storage device of claim 1, wherein the controller tracks the set of incoming host commands to determine that the host workload is a non-long-range random write workload and the controller switches to a second state.

8. The storage device of claim 1, wherein the controller switches to a second state when the storage device enters one of an idle state and a low power mode.

9. The storage device of claim 1, wherein the controller triggers a second state based on the host workload and enables updates to the cache address table.

10. The storage device of claim 1, wherein the controller determines that the host workload is a long-range random read workload, triggers a second state based on the host workload and enables updates to the cache address table.

11. The storage device of claim 1, wherein the controller flushes contents in the cache address table to the persistent memory and invalidates msets mappings in the cache address table when the storage device enters the first state to maintain a chronology of L2P updates.

12. A storage device to improve random write processing and performance on the storage device, the storage device comprises:
a persistent memory to store a logical-to-physical (L2P) table that includes a mapping of logical block addresses in a host command to physical addresses on the persistent memory;
a volatile memory including a cache address table to store msets in the L2P table and a ulayer to store updates to msets in the L2P table; and
a controller to receive a host write command, track a set of incoming host commands to determine a host workload, trigger a first state on the storage device based on a first host workload, disable interaction with the cache address table and update the ulayer with mapping information in the host write command while the storage device is in the first state, and trigger a second state on the storage device based on a second host workload and enable interaction with the cache address table while the storage device is in the second state.

13. A method for improving random write processing and performance on a storage device, the storage device comprises a controller to execute the method comprising:
receiving host commands;
tracking a set of incoming host commands to determine a host workload;
triggering a first state on the storage device based on a first host workload; and
disabling interaction with a cache address table and updating a ulayer with mapping information in the host command while the storage device is in the first state.

14. The method of claim 13, further comprising flushing msets in the cache address table to a persistent memory and invalidating mset mappings in the cache address table when the storage device enters the first state.

15. The method of claim 13, further comprising using slots in the cache address table for consolidation of the ulayer while the storage device is in the first state, flushing msets in the cache address table to a persistent memory, and invalidating mset mappings in the cache address table while the storage device is in the first state.

16. The method of claim 13, further comprising tracking the set of incoming host commands to determine that the host workload is a non-long-range random write workload and switching to a second state.

17. The method of claim 13, further comprising switching to a second state when the storage device enters one of an idle state and a low power mode.

18. The method of claim 13, further comprising triggering a second state based on the host workload and enabling updates to the cache address table.

19. The method of claim 13, further comprising determining that the host workload is a long-range random read workload, triggering a second state based on the host workload, and enabling updates to the cache address table.

20. The method of claim 13, further comprising maintaining a chronology of L2P updates by flushing contents in the cache address table to a persistent memory and invalidating msets mappings in the cache address table while the storage device is in the first state.
